(19) United States
(12) Patent Application Publication
(10) Pub. No.: US 2015/0177915 A1
(43) Pub. Date: Jun. 25, 2015

(54) APPARATUS FOR DISPLAYING IMAGES AND DRIVING METHOD THEREOF, METHOD FOR PROCESSING INFORMATION RELATED TO CLOUD INFRASTRUCTURE, METHOD FOR SETTING RELATION BETWEEN CLOUD INFRASTRUCTURE RESOURCES AND COMPUTER-READABLE RECORDING MEDIUM

(71) Applicant: SAMSUNG ELECTRONICS CO., LTD., Suwon-si (KR)

(72) Inventors: Jong-lok KIM, Seoul (KR); Sung-soo KIM, Seoul (KR); Song-hun KIM, Seongnam-si (KR); Sung-moon CHUNG, Yongin-si (KR)

(73) Assignee: SAMSUNG ELECTRONICS CO., LTD., Suwon-si (KR)

(21) Appl. No.: 14/580,966

(22) Filed: Dec. 23, 2014

(30) Foreign Application Priority Data
Dec. 24, 2013 (KR) 10-2013-0162178

(51) Int. Cl. G06F 3/0481; H04L 29/08; H04L 12/26

(52) U.S. Cl. CPC G06F 3/0481; H04L 43/0876; H04L 67/10

(57) ABSTRACT

An apparatus for displaying images, a driving method thereof, a method for processing information related to cloud infrastructure, a method for setting correlation between cloud infrastructure resources, and a computer-readable recording medium are provided. An image displaying apparatus includes a user interface configured to receive from a user topology information to build an infrastructure required for a cloud service on a resource which is composed or part of the infrastructure, an infrastructure organization determination unit configured to, using a correlation among resources which compose a preset infrastructure, determine whether the received topology information is suitable for the correlation, and a communication interface configured to transmit the information to a cloud service providing apparatus to build the infrastructure using topology information determined according to the result of determination.

### CROSS-REFERENCE TO RELATED APPLICATION(S)

This application claims priority from Korean Patent Application No. 10-2013-0162178 filed on Dec. 24, 2013 in the Korean Intellectual Property Office, the disclosure of which is incorporated herein by reference in its entirety.

### BACKGROUND

1. Field

Aspects of the exemplary embodiments relate to an apparatus for displaying images, a driving method thereof, a method for processing information related to cloud infrastructure, a method for setting a correlation between cloud infrastructure resources, and a computer-readable recording medium and, more particularly, to an image displaying apparatus which is able to build infrastructure in a one-stop method, for example, when building an infrastructure on an Amazon website to receive a cloud service at various user apparatuses including a smartphone and a smart TV, a method for driving of an image displaying apparatus, a method for processing cloud infrastructure information, a method for setting a correlation of cloud infrastructure resources, and a computer-readable recording medium.

2. Description of the Related Art

In general, cloud computing means a computing which provides a plurality of users with IT (Information Technology) services having a high level of expandability by utilizing Internet technologies. In a cloud computing environment, users access a large-scaled computer through various Internet-connected terminals, selectively rent IT resources, such as an application program, storage, a virtual computer server (or a virtual machine), in a desired amount when the users desire, and pay for an amount used.

Devices such as smartphone, smart TV which may by a substitute for a personal computer (PC) have been developed, and many devices are available now. To satisfy needs of increasing number of customers, many companies have a service server using cloud infrastructure (hereinafter, “cloud infra” or “infra”).

The conventional art related to the configuration of this service is discussed below. For example, it may be assumed that a user configures a new load balancer and two servers in the cloud environment. In the conventional art, generation of one new load balancer and two servers is requested as a cloud service, and is under a standby mode until generation of the above three is completed. After generation of the three is completed, the generated load balancer is set. And then, two newly-generated servers are connected to the load balancer.

As described above, in the conventional art, an entire system infra may be configured by understanding a correlation of resources of the infra to organize a service infra, or by several steps through a text-based user interface (UI) which satisfies and may provide correlation of individual infra resources. That is, in order to configure a service using many functions provided by the cloud infra, a text-based UI is utilized to generate and set individual infra.

As to the conventional arts, it was hard to understand or know the configuration of a topology of the entire system at a glance, regarding each infra organization status, or problematic area of the present infra. For example, even understanding if is possible, characteristics of each infra organization and correlation among resources should be understood to compose the entire cloud infra, jobs by infra resources such as generation, correction, deletion, and connection should be performed in stages, and infra of the entire cloud should be produced, and thus, for a user who has little understanding about the foregoing, it is hard to configure infra, and even for skilled users it is hard to find out or understand an entire topology at a glance.

Further, when organizing one cloud infra, if a resource is allocated without considering a correlation of an entire topology, jobs may be repeated unnecessarily, or when the configuration is wrong, the configuration may need to be newly generated.

Furthermore, when organizing cloud infra, infra should be generated by each resource, and jobs that may have many steps should be performed for connection of the related resources. Thus, this may be burdensome and require a lot of time.

### SUMMARY

Additional aspects and/or advantages will be set forth in part in the description which follows and, in part, will be apparent from the description, or may be learned by practice of the embodiments.

An aspect of the exemplary embodiments is designed in accordance with the above-described necessities and is purposed to provide an image displaying apparatus which is able to build infrastructure in a one-stop method, for example, when building an infrastructure on an Amazon website to receive a cloud service at various user apparatuses including a smartphone and a smart TV, a method for driving of an image displaying apparatus, a method for processing cloud infrastructure information, a method for setting correlation of cloud infrastructure resources, and a computer-readable recording medium.

According to an aspect of an exemplary embodiment, an image displaying apparatus includes a user interface configured to receive from a user topology information to build an infrastructure required for a cloud service on a resource which is composed of the infrastructure, an infrastructure organization determination unit configured to, using correlation among resources which compose a preset infrastructure, determine whether the received topology information is suitable for the correlation, and a communication interface configured to transmit the information to a cloud service providing apparatus to build the infrastructure using topology information determined according to the result of the determination.

The infrastructure organization determination unit may set at least one of a generation sequence of the resource as correlation among the resources, coherence on a subordinate relation and a depth which is a hierarchical structure of the resource, and parallel job possibility where a plurality of processing is available at the same time based on the topology information.

The infrastructure organization determination unit may divide generation of the resource or a connection among the resources into a unit of a task, and perform asynchronous parallel jobs in a task group unit which groups tasks that are capable of simultaneous performance.

The infrastructure organization determination unit may preset processing a sequence of a job in the task group unit, and process the topology information in a one-stop method according to the preset sequence.

The tasks that are simultaneously available may be available among the resources having the same characteristic.

The image displaying apparatus may further include a display which displays the topology information and the determined topology information on a screen.

The communication interface may receive from the cloud service providing apparatus state information upon generation and connection of the resource which is composed based on the determined topology information, transmit to the cloud service providing apparatus a request for final infrastructure organization by a user according to the received state information, and, when the request is received, the cloud service providing apparatus may build an infrastructure to provide the cloud service.

The apparatus may further include a controller that controls the communication interface, when the topology information is received, to execute the infrastructure organization determination unit, and transmit the determined topology information.

A method for driving an image displaying apparatus according to an exemplary embodiment includes receiving from a user topology information to build an infrastructure required for a cloud service using a resource which is composed of the infrastructure, using correlation among resources which is composed of a preset infrastructure, determining whether the received topology information is suitable for the correlation, and transmitting the information to a cloud service proving apparatus to build the infrastructure using topology information determined according to the result of determination.

The determining may include setting at least one of a generation sequence of the resource as correlation among the resources, coherence on subordinate relation and depth which is a hierarchical structure of the resource, and parallel job possibilities where a plurality of processings are available at the same time based on the topology information.

The determining may include dividing generation of the resource or a connection among the resources in a unit of a task and performing asynchronous parallel jobs in a task group unit which groups tasks that are simultaneously.

The determining may include a presetting processing sequence of a job in the task group unit and processing the topology information in a one-stop method according to the preset sequence.

The tasks that are simultaneously available may be available among the resources having the same characteristic.

The method may further include displaying the topology information and the determined topology information on a screen.

The transmitting may include receiving from the cloud service providing apparatus state information on generation and connection of the resource which is composed based on the determined topology information and transmitting to the cloud service providing apparatus a request for final infrastructure organization by a user according to the received state information, and when the request is received, the cloud service providing apparatus builds an infrastructure to provide the cloud service.

The method may further include controlling to execute the determination process when the topology information is received and transmitting the determined topology information.

A method for processing cloud infrastructure information according to an exemplary embodiment includes receiving from a user topology information to build an infrastructure required for a cloud service using a resource which is composed of the infrastructure, determining whether the received topology information satisfies regulation information which presets a correlation among resources which organize the infrastructure, and determining the topology information according to the determined result and providing the determined topology information to build the infrastructure.

The determining may include determining at least one of a generation sequence of the resource, coherence on subordinate relation and depth which is a hierarchical structure of the resource, and parallel jobs possibility where a plurality of processing is available at the same time based on the topology information.

The determining the topology information may include, when the plurality of processing is simultaneously available, performing asynchronous parallel job in a task group unit which groups tasks of generation of the resource or connection among the resources and determining the topology information.

A method for setting correlation between cloud infrastructure resources according to an exemplary embodiment includes defining a generation job sequence from a upper depth based on a predefined depth information for resources required to build a cloud service infrastructure; when generation job of upper and lower resources is completed, setting a connection job of the related resources; and storing a result of the defined generation job sequence and the set connection job.

The defining a generation job sequence may include defining coherence on whether the resources are connected according to a depth of top and bottom relation and subordinate relation, wherein the storing comprises additionally storing a result of the defined coherence.

A method for setting correlation between the cloud infrastructure resources may further comprise redefining a generation job sequence by grouping jobs which are capable of parallel generation according to a priority attribute, from the generation job sequence of the defined resource, wherein the storing may include additionally storing a result of the redefined generation unit.

According to an exemplary embodiment, a computer-readable recording medium which executes a could infrastructure information processing method including receiving from a user topology information to build an infrastructure required for a cloud service using a resource which is composed of the infrastructure; determining whether the received topology information satisfies regulation information which sets correlation among resources which organize the infrastructure and determining the topology information according to the determined result and providing the resource.

Another aspect of the exemplary embodiments a computer readable non-transitory storage storing a method for driving an image displaying apparatus is provided, the method including receiving from a user topology information to build an infrastructure required for a cloud service on a resource which is composed of the infrastructure, using a correlation among resources which is composed of a preset infrastructure, determining whether the topology information is suitable for the correlation producing a suitable topology, and transmitting the information to a cloud service proving apparatus to build the infrastructure using the suitable topology information determined according to the result of the determining.

A further aspect of the exemplary embodiments includes a method of receiving a topology defining an infrastructure for a cloud service, correlating resources of a preset cloud infrastructure to the topology, determining whether the resources of the correlating are suitable to the topology, and transmitting the topology to the cloud service to build the infrastructure responsive to the determining.

### BRIEF DESCRIPTION OF THE DRAWINGS

The above and/or other aspects will be more apparent and more readily appreciated from the following description of the embodiments with reference to the accompanying drawings, in which:

FIG. 1 is a view illustrating a system for building a cloud infrastructure according to an exemplary embodiment,

FIG. 2 is a block diagram illustrating structure of an image displaying apparatus of FIG. 1,

FIG. 3 is a view provided to explain a cloud infrastructure according to an exemplary embodiment,

FIG. 4 is a view provided to explain the configuration of topology according to an exemplary embodiment,

FIG. 5 is a view illustrating a process for building a cloud infrastructure according to an exemplary embodiment,

FIG. 6 is a flowchart illustrating a process for driving of an image display apparatus according to the first exemplary embodiment,

FIG. 7 is a flowchart illustrating a process for driving of an image display apparatus according to the second exemplary embodiment,

FIG. 8 is a flowchart illustrating a process for processing cloud infrastructure information according to an exemplary embodiment, and

FIG. 9 is a flowchart illustrating a process for setting correlation of cloud infrastructure resources according to an exemplary embodiment.

### DETAILED DESCRIPTION

Reference will now be made in detail to the embodiments, examples of which are illustrated in the accompanying drawings, wherein like reference numerals refer to the like elements throughout. The embodiments are described below to explain the embodiments by referring to the figures.

In the following description, like drawing reference numerals are used for the like elements, even in different drawings. The matters defined in the description, such as detailed construction and elements, are provided to assist in a comprehensive understanding of exemplary embodiments. However, exemplary embodiments may be practiced without those specifically defined matters. Also, well-known functions or constructions are not described in detail because they would obscure the application with unnecessary detail.

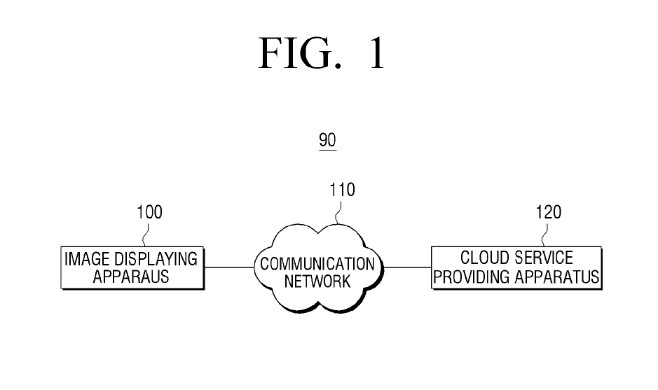

FIG. 1 is a view illustrating a system for building a cloud infrastructure according to an exemplary embodiment.

As illustrated in FIG. 1, a system 90 for building a cloud infra according to an exemplary embodiment includes an image displaying apparatus 100, a communication network 110, and a cloud service providing apparatus 120.

The image displaying apparatus 100 includes an image displaying apparatus of a touch screen type, a self-emission display such as organic light-emitting diode (OLED), or non-emissive displaying apparatus such as liquid crystal display (LCD). Display apparatuses not only include a TV but may also include a computer or mobile phone. Herein, non-emissive displaying apparatus means that a separate backlight unit which provides light is provided. In this case, a backlight unit may include light-emitting diode (LED) or the like.

The image displaying apparatus 100 according to an exemplary embodiment accesses the cloud service providing apparatus 120 and builds infra to receive or provide a cloud service. For example, in case of a certain company, the number of users who access during weekdays and weekends may be different. In this case, the company may flexibly build a cloud infra having a configuration different from each other during weekdays or weekends, to cope with the different configuration. This is important, as cost is involved. As such, in order to improve efficiency, the image displaying apparatus 100, for example, may store and execute a program to build a cloud infra inside. In accordance with execution of an internal program, when a user configures a topology to build infra through the image displaying apparatus 100, the image displaying apparatus 100 may determine whether the configuration of the topology is suitable, and if it seems unsuitable after determination, the result may be notified to a user, so that a user may finally determine (configure) the topology. In this process, the image displaying apparatus 100 may provide information regarding resources that may be generated or used. In addition, by providing the finally determined topology information to the cloud service providing apparatus 120, information for building infra may be processed with a one-stop method. The image displaying apparatus 100 may execute a program stored in an external apparatus and perform the aforementioned operations, instead of storing and executing an internal program. Therefore, an exemplary embodiment will not be limited thereto.

The image displaying apparatus 100, in order to determine whether organization of topology is adequate, may determine whether a generation sequence of resources, such as a server which organizes cloud infra, and a connection sequence among resources are appropriate; whether a connection among resources which organize an upper or lower depth (or hierarchy) of the resources is appropriate; or whether asynchronous parallel jobs may be performed in a unit of a task group which groups tasks available to perform simultaneous jobs. Herein, a task may mean generation of resources or a unit job related to the connection of resources, and a job may mean a task group unit which groups the unit tasks. In other words, a job is a group which groups jobs of resources having the same characteristics. For example, when a resource which organizes infra is an instance, the job means integration of generation and connection related to the instance.

Through the above process, when an organization of topology is finally completed (or determined), the image displaying apparatus 100 provides organization information of the corresponding topology to the cloud service providing apparatus 120 via the communication network 110. Then, the image displaying apparatus 100 may receive state information on the resources organized based on organization information of the topology. In other words, it may be assumed as an example that the image displaying apparatus 100 organizes topology by connecting one load balancer, two instances, two storages, and 2 static IP, and may provide the cloud service providing apparatus 120 with relevant organization information. In this case, as to generation and connection of the resources, a time required in the cloud service providing apparatus 120 is different. Therefore, the image displaying apparatus 100 may receive from the cloud service providing apparatus 120 state information in a sequence of a completion of the generation of jobs. Further, a user of the image displaying apparatus 100 may additionally organize topology in accordance with state information. In this case, added topology may be topology in a task or job unit. If there is no additional job, a user of the image displaying apparatus 100 may provide a request for the organization of a final infra to the cloud service providing apparatus 120, and complete building of the infra.

In view of the above, the image displaying apparatus 100 may display an organization of a topology on a screen as a graphic, and check the processing of the organization of topology by the cloud service providing apparatus 120. Through this, the efficiency of job may be improved. However, the image displaying apparatus 100 may not necessarily display organization of a topology on a screen as a graphic, and may display as a text language description, not a graphic.

In summary, the image displaying apparatus 100 may calculate a logical relation of resources and organize automated infra structure in a one-stop method, so that a user may easily organize a system, even if a user has no idea about a correlation between infra resources to organize a cloud infra. For this, the image displaying apparatus 100 automatically proves a generation sequence of the resources, depth, or subordinate relation. Further, the image displaying apparatus 100, based on resource generation sequence, depth, or subordinate relation, may calculate an entire job sequence by grouping tasks capable of parallel operation, and set the calculated sequence, so that parallel jobs with the cloud service providing apparatus 120 may be performed.

The communication network 110 includes both wired and wireless communication networks. Herein, wired network includes internet network such as a cable network and public switched telephone network (PSTN), and wireless communication network includes code division multiple access (CDMA), wideband code division multiple access (WCDMA), global system for mobile communications (GSM), evolved packet core (EPC), long term evolution (LTE), wireless broadband (WiBro) network, or the like. Accordingly, when the communication network 110 is a wired communication network, an access point may access an exchange office, but in case of wireless communication network, data processing is available by accessing serving GPRS support node (SGSN) or gateway GPRS support node (GGSN) which is operated by a telecommunication company, or by accessing various repeaters such as base station transmission (BTS), NodeB, and e-NodeB.

Further, the communication network 110 includes a small-scaled access point (AP) such as Femto and Pico base stations which is largely installed within a building. Herein, Femto or Pico base stations are divided depending on how many image displaying apparatuses 100 may be accessed based on the classification of a small-scaled base station. Of course, the AP includes a short-distance communication, module to perform short-distance communication such as ZigBee and Wi-Fi, with the image displaying apparatus 100. In an exemplary embodiment, short-distance communication may have various specifications other than Wi-Fi such as radio frequency (RF) including Bluetooth, ZigBee, infrared data association (IrDA), ultra high frequency (UHF), very high frequency (VHF) and ultra-wideband (UWB), or the like. Accordingly, the AP extracts a location of a data packet, designates an optical communication route regarding the extracted location, and transmits the data packet to a next apparatus, for example, the image displaying apparatus 100 along the designated communication route.

The cloud service providing apparatus 120, for example Amazon web services (AWS), indicates a large-scaled computer group which provides an application program interface (API). The large-scaled computer group includes a virtual server, or the like, and may lend a user required IT resources, such as an application program, a storage, and a virtual computer server, at a time when a user requires. Then, the cloud service providing apparatus 120 receives payment for the use amount.

According to an exemplary embodiment, the cloud service providing apparatus 120 receives topology information through the image displaying apparatus 100, and builds an infra for cloud service according to a command by a user. In this process, the cloud service providing apparatus 120, when a job is completed by tasks or jobs, may provide state information to the image displaying apparatus 100. Thereafter, when a user additionally organizes a topology based on the corresponding state information, the infra may be built again, and the state information also may be provided to the image displaying apparatus 100. In this process, when a user finally asks for an organization of the infra in the image displaying apparatus 100, the infra building operation is completed accordingly. Further, the cloud service providing apparatus 120, in the process of performing a job by tasks or jobs, may perform parallel processing for the image displaying apparatus 100 and topology.

As a result of the above organization, according to an exemplary embodiment, when a user would like to build and use a cloud infra, even though the user does not know about correlation and characteristics of resources, a user may conveniently build cloud infra if a topology can be built.

When building the cloud infra, it is not necessary to ponder whether or not generation order or location of depth is appropriate when organizing cloud infra, as it is automatically verified while organizing, and thus, user convenience is improved.

Further, by dividing the entire generation job of the cloud infra into individual resource generation tasks and related resources connection tasks, and utilizing generation job by using a job sequence which calculates an order of processing of each task, generation job is automated with a one-stop operation, and, thus, time is saved.

In addition, in a cloud infra organization job, when job tasks capable of parallel operations are extracted, and when next relevant task condition is checked whenever each task is completed, and if the condition is satisfied, jobs are performed in an asynchronous manner. Accordingly, a time required for organizing the entire cloud infra may be minimized.

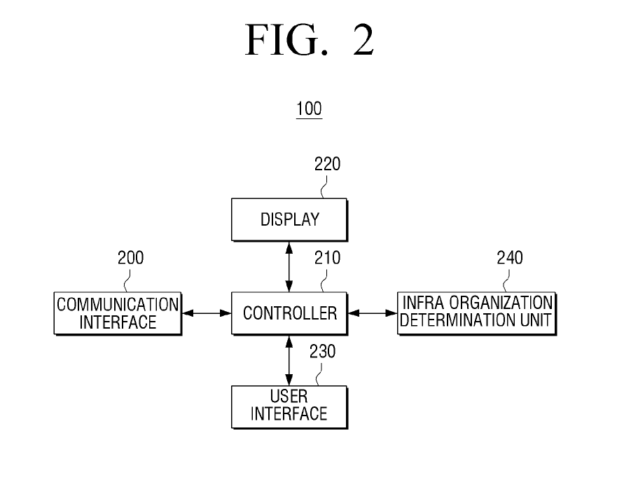

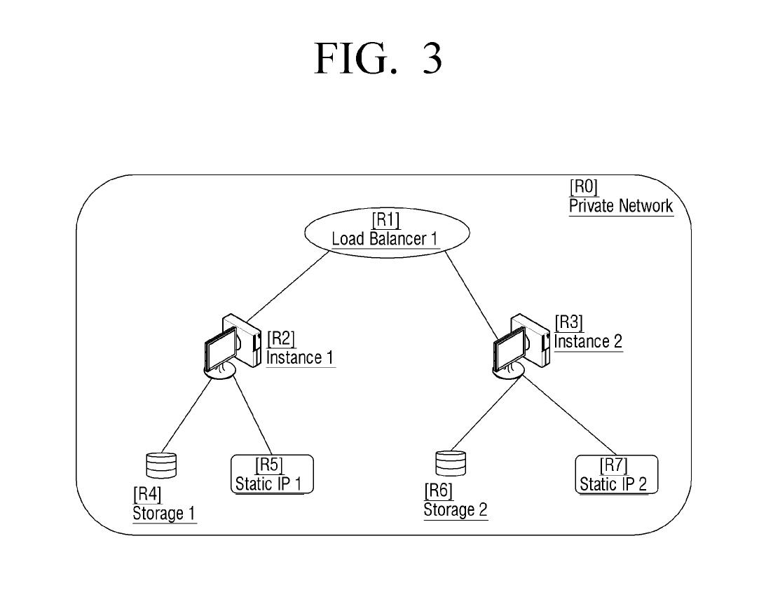

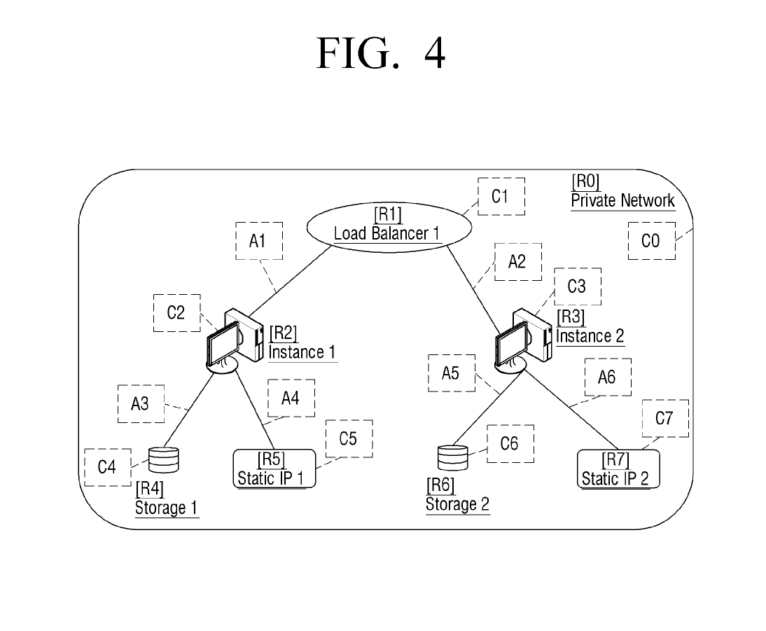

FIG. 2 is a block diagram illustrating structure of an image displaying apparatus of FIG. 1, FIG. 3 is a view provided to explain a cloud infrastructure according to an exemplary embodiment, and FIG. 4 is a view provided to explain the configuration of topology according to an exemplary embodiment.

Referring to FIG. 2 along with FIG. 1, the image displaying apparatus 100 according to an exemplary embodiment may include a part or a whole of the communication interface 200, the controller 210, the display 220, the user interface 230, and the infra organization determination unit, and may further include storage (not illustrated).

Herein, including a part or whole means an organization in which some elements, such as the storage, are omitted, or some elements, such as the determination unit 240, may be incorporated with other elements, such as the controller 210. For easier understanding, including whole elements is described.

The communication interface 200 provides topology information a user finally determines to the cloud service providing apparatus 120, and receives state information on a state of the building of an infra in the cloud service providing apparatus 120 based on the provided topology information. Herein, topology information may be at least one of a task or a job unit.

The controller 210 plays a role of controlling a part or a whole of the communication interface 200 within the image displaying apparatus 100, the display 220, the user interface 230, and the infra organization determination unit 240. In other words, the controller 210 may control the infra organization determination unit 240 to execute a program to build an infra to receive or provide a cloud service upon a request by a user. Through this, the controller 210 may provide the infra organization determination unit 240 with topology information, for example, topology information a user organizes through the interface 230. Herein, the topology information may be displayed as graphic on the display 220 so that a user may easily understand the entire state. Then, the controller 210 may present to a user a result of finding a correlation among individual resources based on the topology information in the infrastructure organization unit 240 and finally determine the topology information. In addition, the controller 210 may control the interface 200 so that the finally determined topology information may be transmitted to the cloud service providing apparatus 120.

The display 220, upon request of a user, may display an infra building program on a screen and display organization of the topology which a user built through the program as a graphic. In this case, the display 220 may additionally display a determination result provided by the infra organization determination unit 240 on a screen, so that a user may amend the topology information which a user initially organized.

The user interface 230 may include a key input unit. The user interface 230 may provide various commands through the key input unit. The user interface 230 may, for example, organize a topology to build infra on the display 220, give a command to transmit the finally determined topology information to the cloud service providing apparatus 120, and provide a request for building the final infra to the cloud service providing apparatus 120.

The infra organization determination unit 240 enables a user to correctly organize topology information according to a preset relation rule. In addition, the infra organization determination unit 240, being interlocked with the cloud service providing apparatus 120, causes an asynchronous parallel job to be performed in accordance with a preset job sequence. In this case, the parallel job may be performed based on state information provided by the cloud service providing apparatus 120. As such, an operation which uses state information may be more suitable, when topology information is provided several times.

Further, the infra organization determination unit 240 has preset information regarding the generation sequence and subordinate relation of individual resources to build the infra. Through this, when it seems that there is an error in topology of a user, it may be verified. In addition, the infra organization determination unit 240 groups tasks available for parallel jobs based on the generation sequence of resources, depth, or subordinate relation, and presets a calculated entire job sequence. Through this, performing parallel jobs of topology information which a user organized according to a preset sequence is possible.

Referring to FIG. 3, the regulation of the infra organization determination unit 240, that is, a process for presetting a correlation among resources is described hereinbelow. First of all, in order to organize a cloud infra in a type of FIG. 3, a correlation among resources which is required to organize cloud infra topology is defined based on information on characteristics of each resource. Depth means a relation of a top and bottom among each resource. For example, an instance connected to a load balancer is a lower node of a load balancer. Recursive means whether or not a resource of the same type may be organized at a lower position. It can be divided into possibility and impossibility. For example, a load balancer may have another load balancer in a lower position. Dependency means a resource which may be located in an upper position of each resource. For example, a storage is a lower resource of an instance, and may not be connected to a lower position of resources, such as a load balancer or static IP. Dependent means whether or not a resource may exist independently. Dependent may be divided into possibility, possible but with a logic error, and impossibility. For example, a static IP is a meaningless resource if it is not mapped with an instance and independently exists. In this case, a logical error may be perceived and verified. Priority means a resource which should be generated ahead of generation of a corresponding resource. For example, an instance has dependency with a private network, and thus, if private network resource is not generated, the instance may not be generated. On the other hand, storage is an independent resource having no dependency, and thus, may be immediately generated without prior conditions. Of course, the infra organization determination unit 240 may check coherence and provide a guide to a user who makes or designates the topology when organizing a graphic topology as illustrated in FIG. 3 based on the logical relation among cloud infra resources.

Preset information as described above may be stored in the infra organization determination unit 240 as a table such as Table 1 and Table 2, or stored in an outside storage. Table 1 describes an example of correlation among major resources, and Table 2 describes an example of correlation among resources based on topology of FIG. 3.

TABLE 1

| Resource | | | | | |
|---|---|---|---|---|---|
| Type | Depth | Recursive | Dependency | Dependant | Priority |
| Private | 0 | 0 | — | ◯ | — |
| Network | | | | | |
| Load | 1 | 0 | Private Network | ◯ | — |
| Balancer | | | | | |
| Instance | 2 | X | Private Network, | ◯ | Private |
| | | | Load Balancer | | Network |
| Storage | 3 | X | Private Network, | Δ | — |
| | | | Instance | | |
| Static P | 3 | X | Private Network, | Δ | — |
| | | | Instance | | |

TABLE 2

| Resource ID | Resource Name | Depth | Recursive | Dependency | Dependant | Priority |
|---|---|---|---|---|---|---|
| R0 | Private Network | 0 | ◯ | — | ◯ | — |
| R1 | Load Balancer 1 | 1 | ◯ | R0 | ◯ | — |
| R2 | Instance 1 | 2 | X | R0, R1 | ◯ | R0 |
| R3 | Instance 2 | 2 | X | R0, R1 | ◯ | R0 |
| R4 | Storage 1 | 3 | X | R0, R2 | Δ | — |
| R5 | Static IP 1 | 3 | X | R0, R2 | Δ | — |
| R6 | Storage 2 | 3 | X | R0, R3 | Δ | — |
| R7 | Static IP 2 | 3 | X | R0, R3 | Δ | — |

In addition, the infra organization determination unit 240 may draw a job of an entire workflow, that is, a job sequence, to automate generating of the cloud infra including a plurality of resources by using a correlation among cloud resources, and preset a result thereof.

A method for drawing the topology may be explained with reference to FIG. 4. In the topology of FIG. 4, resource generation task has a ‘C’ task ID, and a resource connection task has a ‘A’ task ID. First of all, all the cloud infra resources may be primarily defined through pre-defined depth information as in Table 3 from the upper depth. Resources having the same depth are randomly serialized.

TABLE 3

No.

| | 1 | 2 | 3 | 4 | 5 | 6 | 7 | 8 |
|---|---|---|---|---|---|---|---|---|
| Task ID | C0 | C1 | C2 | C3 | C4 | C5 | C6 | C7 |

Then, in the primarily arranged source generation, jobs capable of parallel operation are may be grouped according to a priority attribute and generation task frequency may be redefined. For example, in Table 4, C2 and C3 jobs having dependency over C0 may proceed with tasks after C0 is generated. If there is no dependency, C0, C1, C4, C5, C6, C7 which may independently exist may be simultaneously performed.

TABLE 4

| No. | Task ID |
|---|---|
| 1 | C1, C2, C3, C4, C5, C6, C7 |
| 2 | C2, C3 |

Correlation among resources having a connection relation may be described as a connection task as in A1˜A6 of Table 5.

TABLE 5

| Task ID | Upper Task ID | Lower Task ID |
|---|---|---|
| A1 | C1 | C2 |
| A2 | C1 | C3 |
| A3 | C2 | C4 |
| A4 | C2 | C5 |
| A5 | C3 | C6 |
| A6 | C3 | C7 |

Whenever each resource generation task is completed, a related resource connection task is checked, and when all the paired upper and lower tasks are completed, the connection task is performed.

Accordingly, a case where a resource is generated in the time sequence as shown below may be assumed, and by applying the aforementioned rule, a job sequence of generation and connection tasks may be calculated. The calculation process may be described with respect to Table 6.

Resource generation time sequence scenario: R1→R5→R0→R7→R4→R2→R3→R6

TABLE 6

| Job | | | |
|---|---|---|---|
| Sequence | Task ID | Reasons | Resource generation processing steps |
| 1 | C0, C1, C4, | Tasks available for | — |
| | C5, C6, C7 | parallel operation | |
| 2 | C2, C3 | Proceed with C2, C3 | R1 [symbol] R5 [symbol] R0 |
| | | tasks after generation | |
| | | of R0 | |
| 3 | A1, A3, A4 | When R2 is | R1 [symbol] R5 [symbol] R0 [symbol] R7 [symbol] R4 [symbol] R2 |
| | | generated, | |
| | | simultaneously | |
| | | perform connection | |
| | | tasks with R4, R4, R5 | |
| 4 | A2, A6 | When R3 is | R1 [symbol] R5 [symbol] R0 [symbol] R7 [symbol] R4 [symbol] R2 [symbol] R3 |
| | | generated, | |
| | | simultaneously | |
| | | perform connection | |
| | | tasks with R1, R7 | |
| 5 | A5 | When R6 is | R1 [symbol] R5 [symbol] R0 [symbol] R7 [symbol] R4 [symbol] R2 [symbol] R3 [symbol] R6 |
| | | performed, perform | |
| | | connection task with | |
| | | R3 | |

For example, in Table 6, when a user organizes topology on R1, R5, and R0, a command to organize R2 and R3 according to the rule of correlation may be given.

In the above case, there are a total of five steps of the job sequence, and if the tasks are completed up to A5 task, cloud infra as illustrated in FIG. 4 is automated and organized in one-stop. In this case, based on information on the correlation among individual resources of the cloud infra, the entire organization information may be indicated as graphic topology as illustrated in FIGS. 3 and 4 so that the entire status may be controlled to be easily understood.

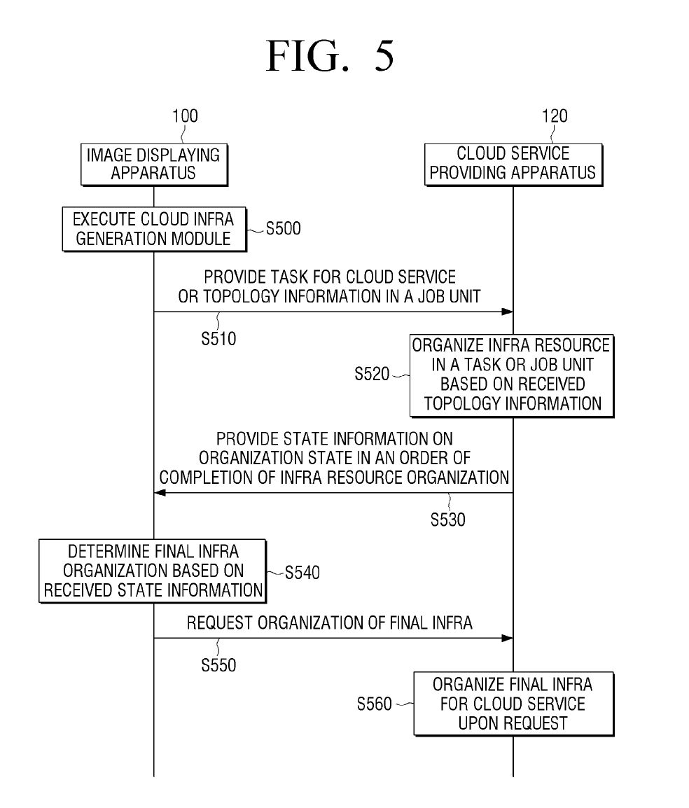

FIG. 5 is a view illustrating a process for building a cloud infrastructure according to an exemplary embodiment.

For easier explanation, when referring to FIG. 5 with FIG. 1, the image displaying apparatus 100 according to an exemplary embodiment may execute a cloud infra generation module (S500) to build an infra to receive the cloud service. Herein, the cloud infra generation module may be the infra organization determination unit 240 of FIG. 2.

Then, the image displaying apparatus 100 provides topology information in a task or a job unit for the cloud service to the cloud service providing apparatus 120 (S510). Herein, the task means the generation or connection of individual resources, and a job is a group of tasks capable of parallel operation.

The cloud service providing apparatus 120, based on the received topology information, organizes an infra resource in a task or a job unit (S520). In other words, when topology information is provided in the image displaying apparatus 100, the information may be processed in a task unit, and if topology information is provided in a job unit, parallel operation with the image displaying apparatus 100 may be performed.

The cloud service providing apparatus 120, when the infra resource organization is completed, provides state information on the state of organization to the image displaying apparatus 100 (S530). A time required for this organization may be different for various types of resources, and, the cloud service providing apparatus 120 notifies about organized resources to the image displaying apparatus 100 in the sequence of completion.

According to an exemplary embodiment, the image displaying apparatus 100 and the cloud service providing apparatus 120 may repeat S520 and S530 for several times. In other words, a user may organize minimum topology only, provide the topology to the cloud service providing apparatus 120, and then additionally organize a further topology on the completed state information.

The image displaying apparatus 100, based on the received state information, may determine whether the final infra may be organized (S540). In other words, the image displaying apparatus 100 may not additionally generate a topology on the completed resources above.

In this case, the image displaying apparatus 100, based on information on the topology which has been performed or examined so far, may request the cloud service providing apparatus 120 to finally organize infra (S550).

The cloud service providing apparatus 120 organizes the final infra upon a request being provided by the image displaying apparatus 100 (S560). Then, the cloud service providing apparatus 120 may provide a separate message notifying that infra is finally organized to the image displaying apparatus 100.

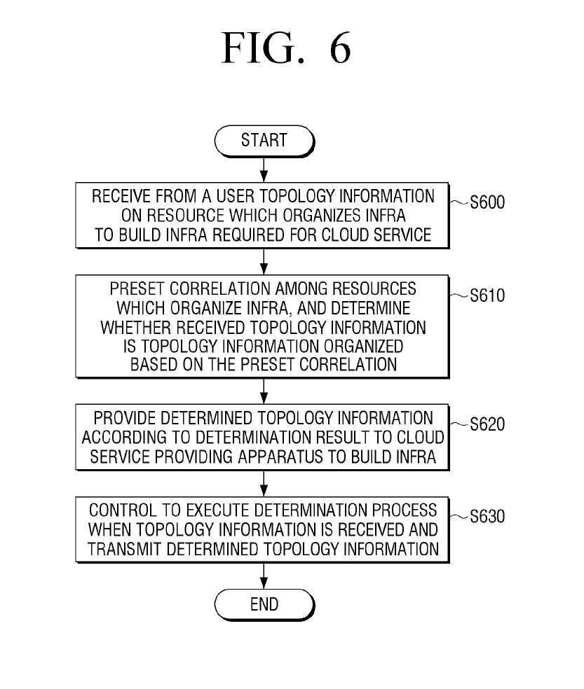

FIG. 6 is a flowchart illustrating a process for driving of an image display apparatus according to the first exemplary embodiment.

For convenience of description, referring to FIG. 6 along with FIG. 1, the image displaying apparatus 100 according to the first exemplary embodiment receives from a user topology information on resources which organize an infra to build infra required for a cloud service (S600).

In addition, ahead of receiving the aforementioned topology information, the image displaying apparatus 100 presets a correlation among resources which organize infra and determines whether the received topology information is topology information which is organized based on the preset relation (S610). In other words, whether a generation sequence of resources which organize the topology, depth, and subordinate relation is suitable, and further, whether parallel operation of tasks in a preset sequence is available by grouping tasks is determined.

Then, the image displaying apparatus 100 may transmit the topology information (S620) which is finally determined according to the determination result to the cloud service providing apparatus 120 so that infra is built based on the topology information (S620). Herein, the finally determined topology information may not be information which may complete the building of the infra based on one request, but may mean the last topology information, after a user performs serial jobs which organize the topology information, when the user believes that no more topology will be organized.

In addition, the controller 210 of the image displaying apparatus 100 as illustrated in FIG. 2, when topology information is received, may control a communication module to perform the determination process and transmit the determined topology information to the cloud service providing apparatus 120.

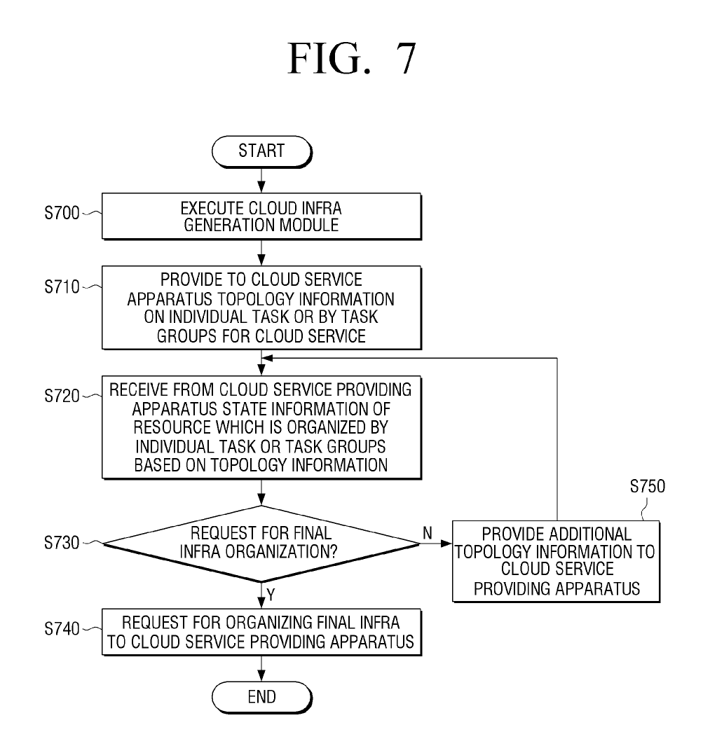

FIG. 7 is a flowchart illustrating a process for driving of an image display apparatus according to the second exemplary embodiment.

For the convenience of description, referring to FIG. 7 along with FIG. 1, the image displaying apparatus 100 according to the second exemplary embodiment may operate a module with a cloud infra generation program stored therein to build a cloud infra, that is, a cloud infra generation module (S700).

Then, the image displaying apparatus 100 provides individual tasks for a cloud service or topology information by task groups to the cloud service providing apparatus (120) (S710). S710 may include one or more processes which provide individual tasks or topology information by task groups. In this step, the image displaying apparatus 100 may perform parallel work to process a task related to the cloud service providing apparatus 120 and topology information.

In addition, the image displaying apparatus 100, based on the provided topology information, receives state information of the individual tasks performed by the cloud service providing apparatus 120 or resources organized by task groups (S720). For example, if there is an error, a request may be made again.

Then, after the image displaying apparatus 100 determines whether there is a request for organizing the final infra from a user (S730), if a user has requested organization of the final infra, the infra organization may be finally requested to the service providing apparatus 120 (S740). Accordingly, the cloud service providing apparatus 120 may complete the infra organization to provide a cloud service.

On the other hand, based on the received state information, when a user intends to additionally or further organize topology, the image displaying apparatus 100 may provide with the cloud service providing apparatus 120 topology information additionally added, and repeat S720 and S730. Then, when there is a request by a user for a final organization, S740 may be executed.

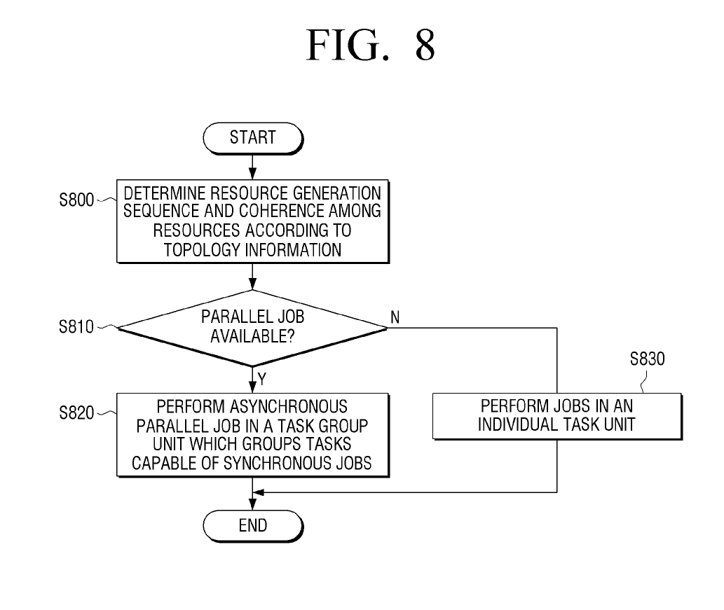

FIG. 8 is a flowchart illustrating a process for processing cloud infrastructure information according to an exemplary embodiment.

FIG. 8 relates to presetting a correlation among individual resources to build an infra in the image displaying apparatus 100 according to an exemplary embodiment, determining whether a user provides topology information according to the preset rules, and making a task execute according to sequence which is set by dividing task groups.

The image displaying apparatus 100 receives topology information related to setting the infra to receive a cloud service and verifies whether the received topology information is suitable for the generation sequence of resources, depth, or subordinate relation (S800). As a result, if it is not suitable, a user may determine the final topology information by amending the process or topology.

Further, the image displaying apparatus 100, for example, may divide the finally determined topology information into a task unit, group tasks capable of parallel operation, and calculate the entire job sequence. Through this, whether or not parallel operation is available may be determined (S810).

As a result of the determination, when parallel job processing is available, the image displaying apparatus 100 performs asynchronous parallel job (S820) for the determined topology information with the cloud service providing apparatus 120, and if parallel job processing is not available, performs a job in an individual task unit (S830).

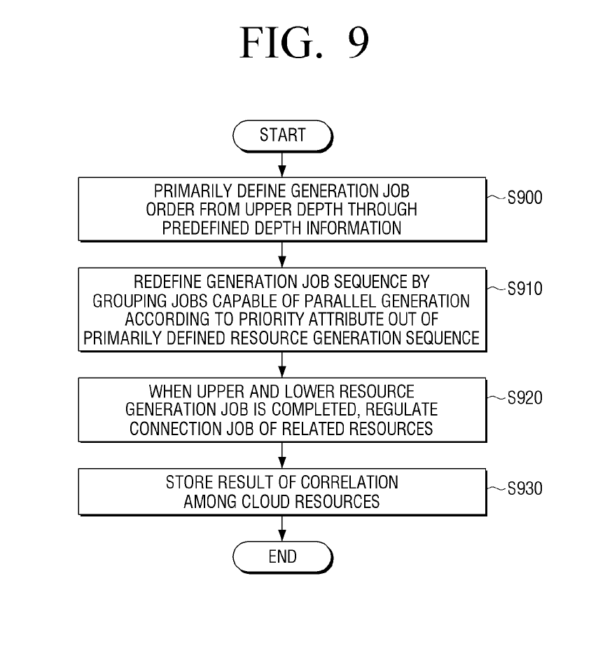

FIG. 9 is a flowchart illustrating a process for setting a correlation of cloud infrastructure resources according to an exemplary embodiment.

FIG. 9 relates pre-setting rules on the correlation among resources which build infra, in order to make the image displaying apparatus 100 perform operations as illustrated in FIG. 8. For example, through this process, one or a plurality of programs may be generated. One image displaying apparatus 100 to draw the rules may be a computer.

The image displaying apparatus 100 according to an exemplary embodiment primarily defines (S900) a generation job sequence from an upper depth, through predefined depth information (S900). This has been described with respect to Table 3 above.

Then, the image displaying apparatus 100 redefines the generation job sequence by grouping jobs capable of parallel generation according to a priority attribute from the primarily defined resource generation sequence (S910). This has been explained with respect to Table 4.

After that, the image displaying apparatus 100, when generating a job of an upper and a lower resource is completed, may regulate connection of job of related resources (S920). As shown in Table 5, for example, connection task A1 may be preset to be generated, when generating a load balancer, which is an upper resource, and instance 1, which is a lower resource, is completed.

Accordingly, when a user organizes the topology through the image displaying apparatus 100, for example, a load balancer, which is an upper resource, and instance 1, which is a lower resource, are organized, and information may be provided to organize A1.

And, the image displaying apparatus 100 may store in a memory information on the entire job sequence which is calculated through grouping of the correlation among cloud resources, that is, resource generation sequence, depth, subordinate relation, and tasks capable of parallel operation, etc. (S930).

It has been described as an embodiment to configure all the components are combined into one unit, or for working in conjunction, but is not necessarily limited to these embodiments. In other words, the object is accomplished, if all components optionally combined with one or more may work. In addition, all components, each one independent of the hardware, but can be implemented as a program module to perform some or all of the features that some or all of each component, optionally in combination with one or a combination of multiple hardware can be implemented as a computer program having Codes and code segments that configure the computer program by those skilled in the art will readily be deduced. These computer programs are stored on a non-transitory computer-readable media, and is read by the computer, which runs an embodiment can be implemented.

The non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as compact disc (CD), digital video disk (DVD), hard disk, Blu-ray disk, USB, memory card, and read-only memory (ROM) and provided therein.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. Any one or more of the software modules described herein may be executed by a dedicated hardware-based computer or processor unique to that unit or by a hardware-based computer or processor common to one or more of the modules. The described methods may be executed on a general purpose computer or processor or may be executed on a particular machine such as the encoding apparatus and decoding apparatus described herein.

Although a few embodiments have been shown and described, it would be appreciated by those skilled in the art that changes may be made in these embodiments without departing from the principles and spirit and the scope which is defined in the claims and their equivalents.

What is claimed is:

1. An image displaying apparatus, comprising:
a user interface configured to receive, from a user, topology information on a resource which is part of an infrastructure to build the infrastructure required for a cloud service;
an infrastructure organization determination unit configured to, using a correlation between resources which compose a preset infrastructure, determine whether the topology information is suitable for the correlation producing suitable topology information; and
a communication interface configured to transmit the topology information to a cloud service providing apparatus to build the infrastructure using the suitable topology information determined.

2. The apparatus as claimed in claim 1, wherein the infrastructure organization determination unit sets at least one of a generation sequence of the resource, coherence on subordinate relation and depth which is a hierarchical structure of the resource, and parallel job possibilities where a plurality of processings are available at a same time based on the topology information as the correlation between the resources.

3. The apparatus as claimed in claim 1, wherein the infrastructure organization determination unit divides one of generation of the resource and a connection between the resources into a unit of a task, and performs asynchronous parallel jobs in a task group unit which groups tasks capable of simultaneous operation.

4. The apparatus as claimed in claim 3, wherein the infrastructure organization determination unit presets a processing sequence of a job in the task group unit, and processes the topology information in a one-stop method according to the sequence.

5. The apparatus as claimed in claim 3, wherein tasks that are simultaneously available for processing are available between the resources having a same characteristic.

6. The apparatus as claimed in claim 1, further comprising:
a display which displays the topology information and the suitable topology information on a screen.

7. The apparatus as claimed in claim 1, wherein the communication interface receives, from the cloud service providing apparatus, state information on generation and connection of the resource which is composed based on the suitable topology information, transmits to the cloud service providing apparatus a request for final infrastructure organization by a user according to the state information, and, when the request is received, the cloud service providing apparatus builds an infrastructure to provide the cloud service.

8. The apparatus as claimed in claim 1, further comprising: a controller which controls the communication interface, when the topology information is received, to execute the infrastructure organization determination unit, and transmit the suitable topology information.

9. A method for driving an image displaying apparatus, comprising:
receiving from a user topology information to build an infrastructure required for a cloud service on a resource which is composed of the infrastructure;
using a correlation among resources which is part of a preset infrastructure, determining whether the topology information is suitable for the correlation producing a suitable topology; and
transmitting the information to a cloud service providing apparatus to build the infrastructure using the suitable topology information determined according to the result of the determining.

10. The method as claimed in claim 9, wherein the determining comprises setting at least one of a generation sequence of the resource as a correlation among the resources, coherence on subordinate relation and depth which is a hierarchical structure of the resource, and parallel job possibilities where a plurality of processings are available at a same time based on the topology information.

11. The method as claimed in claim 9, wherein the determining comprises dividing one of generation of the resource and a connection among the resources into a unit of a task and performing asynchronous parallel jobs in a task group unit which groups tasks that are simultaneously available for processing.

12. The method as claimed in claim 11, wherein the determining comprises presetting a processing sequence of a job in the task group unit and processing the topology information in a one-stop method according to the sequence.

13. The method as claimed in claim 11, wherein the tasks that are simultaneously available for processing are available among the resources having a same characteristic.

14. The method as claimed in claim 9, further comprising:
displaying the topology information and the suitable topology information on a screen.

15. The method as claimed in claim 9, wherein the transmitting comprises receiving from the cloud service providing apparatus state information on generation and connection of the resource which is composed based on the suitable topology information and transmitting to the cloud service providing apparatus a request for final infrastructure organization by a user according to the state information, and
when the request is received, the cloud service providing apparatus builds an infrastructure to provide the cloud service.

16. The method as claimed in claim 9, further comprising:
controlling to execute the determining when the topology information is received and transmitting the suitable topology information.

17. A method for processing cloud infrastructure information, comprising:
receiving from a user topology information to build an infrastructure required for a cloud service on a resource which is part of the infrastructure;
determining whether the topology information satisfies regulation information which presets a correlation among resources which organize the infrastructure; and
determining the topology information according to the determining result and providing a suitable topology information to build the infrastructure.

18. The method as claimed in claim 17, wherein the determining whether comprises determining at least one of a generation sequence of the resource, coherence on subordinate relation and depth which is a hierarchical structure of the resource, and parallel job possibilities where a plurality of processings are available for processing at a same time based on the topology information.

19. The method as claimed in claim 18, wherein the determining the topology information comprises, when the plurality of processings are simultaneously available, performing asynchronous parallel jobs in a task group unit which groups tasks of one of generation of the resource and connection among the resources and determining the topology information.

20. A method for setting a correlation between cloud infrastructure resources, comprising:
defining a generation job sequence from a upper depth based on predefined depth information on resources required to build a cloud service infrastructure;
when generation job of upper and lower resources is completed, setting a connection job of the related resources; and
storing a result of the defined generation job sequence and the set connection job.

21. The method as claimed in claim 20, wherein the defining a generation job sequence comprises defining a coherence on whether the resources are connected according to depth of top and bottom relation and subordinate relation,
wherein the storing comprises additionally storing a result of the defined coherence.

22. The method as claimed in claim 20, further comprising:
redefining a generation job sequence by grouping jobs which are capable of parallel generation according to a priority attribute, from the generation job sequence of the defined resource;
wherein the storing comprises additionally storing a result of the redefined generation job sequence.

23. A computer-readable recording medium which executes a cloud infrastructure information processing method, comprising:
receiving from a user topology information to build an infrastructure required for a cloud service on a resource which is part of the infrastructure;
determining whether the received topology information satisfies regulation information which sets a correlation among resources which organize the infrastructure; and
determining the topology information according to the determining and providing the topology information to build the infrastructure.
